(19) United States
(12) Patent Application Publication
(10) Pub. No.: US 2011/0172879 A1
(43) Pub. Date: Jul. 14, 2011

(54) VEHICLE REPAIR/REPLACEMENT INFORMATION MANAGEMENT SYSTEM, AND VEHICLE ABNORMALITY CAUSE INFORMATION MANAGEMENT SYSTEM

(75) Inventor: Toshiyuki Abe, Aichi-ken (JP)

(73) Assignee: TOYOTA JIDOSHA KABUSHIKI KAISHA, Toyota-shi, Aichi-ken (JP)

(21) Appl. No.: 13/063,292

(22) PCT Filed: Aug. 11, 2009
(86) PCT No.: PCT/IB09/06523

§ 371 Date: Mar. 10, 2011

(30) Foreign Application Priority Data
Sep. 11, 2008 (JP) 2008-233786

(51) Int. Cl. G06F 7/00; G06F 17/30

(52) U.S. Cl. 701/35; 707/821; 707/E17.01

(57) ABSTRACT

When repair/replacement information is acquired by a repair/replacement information acquisition device, feature quantities of vehicle state information acquired by an vehicle state information acquisition device are detected, and a content of repair or parts replacement is estimated using the detected feature quantities of the vehicle state information, and supervised training data. If the result of the estimation accords with the repair/replacement information acquired by the repair/replacement information acquisition device, a storage device is controlled so that the combination of the detected feature quantities of the vehicle state information and the repair/replacement information acquired by the repair/replacement information acquisition device is added to the supervised training data.

### BACKGROUND OF THE INVENTION

1. Field of the Invention

The invention relates to a vehicle repair/replacement information management system that generates and manages information that is stored when an abnormality occurs in a vehicle, and information that is associated in correspondence with repair or with replacement of component parts. The invention also relates to a vehicle abnormality cause information management system that generates and manages information that is stored when an abnormality occurs in a vehicle, and information that is associated in correspondence with a cause of the abnormality.

2. Description of the Related Art

In a related technology, a process in which information regarding a state of a vehicle (including vehicle-mounted appliances, which statement will be omitted below) is monitored, and when an abnormality of the vehicle is detected on the basis of the information, the information regarding the state of the vehicle is stored in a non-volatile storage medium or the like, is performed. The thus-stored information is displayed, in accordance with need, on a monitor display or the like that is externally connected, and is utilized for repair or for replacement of one or more component parts. The inspection regarding the cause of an abnormality is termed the self-diagnosis, or the like. In addition, a process of storing information for self-diagnosis can be performed by a control device that controls the vehicle, concurrently with the vehicle control.

An invention related to this kind of vehicle diagnosis system is disclosed in, for example, Japanese Patent No. 3799795. In this vehicle diagnosis system, in order to make it possible for an external base station to detect a fact that repair has been carried out, failure diagnosis information based on an abnormality detected by self-diagnosis of a vehicle is wirelessly sent from the vehicle to the base station, and then, when it is detected that the abnormality of the vehicle corresponding to the failure diagnosis information has been dissolved (amended), abnormality dissolution information that indicates the dissolution of the abnormality is wirelessly sent from the vehicle to the base station.

Incidentally, the information regarding the state of a vehicle is termed freeze flame data (FFD) or the like, and is generally data in which the output values of vehicle-mounted sensors, state signals, control signals, etc., that are produced when an abnormality occurs are stored in a time series. The FFD is a powerful clue for identifying the cause of an abnormality, but does not directly identify the cause of an abnormality, nor the component part or parts that are to be repaired or replaced. Therefore, when information regarding optimal repair or parts replacement is to be provided for a repair shop or the like, there is a need to perform an appropriate analysis of the cause of an abnormality and to store information in which information regarding the state of the vehicle, such as FFD or the like, and the cause of the abnormality or the component part or parts to be repaired or replaced are associated with each other in correspondence. However, Japanese Patent No. 3799795 mentioned above does not provide description regarding analysis of the cause of an abnormality or the component part to be repaired or replaced.

### SUMMARY OF THE INVENTION

The invention has been accomplished in view of the foregoing problems, and provides a vehicle repair/replacement information management system capable of highly accurately associating the state of a vehicle that is detected when an abnormality of the vehicle occurs and the content of repair or parts replacement that need to be carried out with each other in correspondence, and a vehicle abnormality cause information management system capable of highly accurately associating the state of a vehicle that is detected when an abnormality of the vehicle occurs and the cause of the abnormality with each other in correspondence.

A first aspect of the invention is a system for managing vehicle repair/replacement information that includes: a repair/replacement information acquisition device that acquires repair/replacement information that represents a content of repair or parts replacement carried out to remove an abnormality of a vehicle; an vehicle state information acquisition device that acquires vehicle state information at an occurrence of abnormality of the vehicle, representing a state of the vehicle; a storage device that stores the acquired vehicle state information and the acquired repair/replacement information as a plurality of units of supervised training data in each of which the vehicle state information and the repair/replacement information are associated; and an information processing device that detects a feature of the vehicle state information of each unit of supervised training data stored in the storage device, and that retains a unit of supervised training data if the content of repair or parts replacement described by the repair/replacement information contained in the unit of supervised training data accords with the content of repair or replacement described by the repair/replacement information contained in another unit of supervised training data stored whose detected feature is closest to the detected feature of the unit, and deletes a unit of supervised training data if the content of repair or parts replacement described by the repair/replacement information contained in the unit of supervised training data does not accord with the content of repair or replacement described by the repair/replacement information contained in another unit of supervised training data stored whose detected feature is closest to the detected feature of the unit.

According to the system for managing repair/replacement information, the state of the vehicle detected when an abnormality of the vehicle occurs, and the repair or parts replacement that needs to be carried out can be highly accurately associated with each other.

In the first aspect of the invention, the vehicle state information may be time-series data that has a plurality of items, and the information processing device may detect, as the feature of the vehicle state information, a changed-item pattern occurring at a time point of change of the vehicle state information acquired by the vehicle state information acquisition device.

Besides, in the first aspect of the invention, the information processing device may perform, at a predetermined timing, a process of deleting each piece of data which is contained in the supervised training data stored in the storage device, and whose correlation with other pieces of data is low.

Besides, in the first aspect of the invention, the system for managing repair/replacement information may further include an information providing device that provides information for a user, and when the vehicle state information acquisition device acquires the vehicle state information, the information processing device may perform a function of detecting the feature of the vehicle state information acquired by the vehicle state information acquisition device, and estimating the content of repair or parts replacement by using the detected feature of the vehicle state information, and the supervised training data, and controlling the information providing device so as to provide the user with a result of estimation of the content of repair or parts replacement.

A second aspect of the invention is a device for managing vehicle repair/replacement information that includes: a storage device that stores vehicle state information and repair/replacement information as a plurality of units of supervised training data in each of which the vehicle state information and the repair/replacement information are associated; and an information processing device that detects a feature of the vehicle state information of each unit of supervised training data stored in the storage device, and that retains a unit of supervised training data if a content of repair or parts replacement described by the repair/replacement information contained in the unit of supervised training data accords with the content of repair or replacement described by the repair/replacement information contained in another unit of supervised training data stored whose detected feature is closest to the detected feature of the unit, and deletes a unit of supervised training data if the content of repair or parts replacement described by the repair/replacement information contained in the unit of supervised training data does not accord with the content of repair or replacement described by the repair/replacement information contained in another unit of supervised training data stored whose detected feature is closest to the detected feature of the unit.

Besides, a third aspect of the invention is a method of processing a plurality of units of supervised training data which are stored in a storage device and in each of which vehicle state information and repair/replacement information are associated, the method including the steps of detecting a feature of the vehicle state information of each unit of supervised training data; determining, with regard to each unit of supervised training data, whether or not a content of repair or parts replacement described by the repair/replacement information contained in the unit of supervised training data accords with the content of repair or replacement described by the repair/replacement information contained in another unit of supervised training data stored whose detected feature is closest to the detected feature of the unit; and retaining the unit of supervised training data if the content of repair or replacement described in the unit accords with the content of repair or replacement described in the another unit of supervised training data stored, and deleting the unit of supervised training data if the content of repair or replacement described in the unit does not accord with the content of repair or replacement described in the another one of the stored units.

A fourth aspect of the invention is a system for managing vehicle abnormality cause information that includes: an abnormality cause information acquisition device that acquires abnormality cause information, showing a cause of an abnormality of a vehicle; a vehicle state information acquisition device that acquires vehicle state information at an occurrence of abnormality of the vehicle, representing a state of the vehicle; a storage device that stores the acquired vehicle state information and the acquired abnormality cause information as a plurality of units of supervised training data in each of which the abnormality cause information and a feature of the vehicle state information are associated; and an information processing device that detects the feature of the vehicle state information of each unit of supervised training data stored in the storage device, and that retains a unit of supervised training data if a content of the abnormality cause information described by the abnormality cause information contained in the unit of supervised training data accords with the content of the abnormality cause information described by the abnormality cause information contained in another unit of supervised training data stored whose detected feature is closest to the detected feature of the unit, and deletes a unit of supervised training data if the content of the abnormality cause information described by the abnormality cause information contained in the unit of supervised training data does not accord with the content of the abnormality cause information described by the abnormality cause information contained in another unit of supervised training data stored whose detected feature is closest to the detected feature of the unit.

According to the system for managing abnormality cause information described above, the state of the vehicle detected when an abnormality of the vehicle occurs, and the repair or parts replacement that needs to be carried out can be highly accurately associated.

In the fourth aspect of the invention, the vehicle state information may be time-series data that has a plurality of items, and the information processing device may detect, as the feature of the vehicle state information, a changed-item pattern occurring at a time point of change of the vehicle state information acquired by the vehicle state information acquisition device.

Besides, in the fourth aspect of the invention, the information processing device may perform, at a predetermined timing, a process of deleting each piece of data which is contained in the supervised training data stored in the storage device, and whose correlation with other pieces of data is low.

Besides, in the fourth aspect of the invention, an information providing device that provides information for a user, wherein when the vehicle state information acquisition device acquires the vehicle state information, the information processing device may perform a function of detecting the feature of the vehicle state information acquired by the vehicle state information acquisition device, and estimating the cause of the abnormality by using the supervised training data and the detected feature of the vehicle state information, and controlling the information providing device so as to provide the user with a result of estimation of the cause of the abnormality.

Besides, a fifth aspect of the invention is a device for managing vehicle abnormality cause information that includes: a storage device that stores vehicle state information and repair-replacement information as a plurality of units of supervised training data in each of which vehicle state information and repair-replacement information are associated; and an information processing device that detects a feature of the vehicle state information of each unit of supervised training data stored in the storage device, and that retains a unit of supervised training data if a content of the abnormality cause information described by the repair/replacement information contained in the unit of supervised training data accords with the content of the abnormality cause information described by the repair/replacement information contained in another unit of supervised training data stored whose detected feature is closest to the detected feature of the unit, and deletes a unit of supervised training data if the content of the abnormality cause information described by the abnormality cause information contained in the unit of supervised training data does not accord with the content of the abnormality cause information described by the repair/replacement information contained in another unit of supervised training data stored whose detected feature is closest to the detected feature of the unit.

A sixth aspect of the invention is a method of processing a plurality of units of supervised training data which are stored in a storage device and in each of which vehicle state information and repair/replacement information are associated, the method including the steps of: detecting a feature of the vehicle state information of each unit of supervised training data; determining, with regard to each unit of supervised training data, whether or not a content of abnormality cause information described by the repair/replacement information contained in the unit of supervised training data accords with the content of abnormality cause information described by the repair/replacement information contained in another one of the units stored whose detected feature is closest to the detected feature of the unit; and retaining the unit of supervised training data if the content of the abnormality cause information described in the unit accords with the content of the abnormality cause information described in the another one of the units, and deleting the unit of supervised training data if the content of the abnormality cause information described in the unit does not accord with the content of the abnormality cause information described in the another one of the units.

According to the invention, it is possible to provide a system for managing vehicle repair/replacement information in which the state of a vehicle detected when an abnormality of the vehicle occurs, and the content of repair or parts replacement can be more highly accurately associated, and a system for managing vehicle abnormality cause information in which the state of a vehicle detected when an abnormality of the vehicle occurs, and the abnormality cause can be more highly accurately associated with each other.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a diagram conceptually showing the construction of a repair/replacement information management system 1 in accordance with a first embodiment of the invention;

FIG. 2 is a diagram showing an example of a set of FFD in the first embodiment;

FIG. 3 shows an example of a set of supervised training data in the first embodiment in which the component parts to be repaired or replaced and the feature quantities of the FFD are associated in correspondence;

FIG. 4 is a diagram showing how the component parts to be repaired or replaced are estimated from the present FFD in the first embodiment;

FIG. 5 is an example of a flowchart of a process that is executed by an information processing device 30 in the first embodiment;

FIG. 6 is an example of a flowchart of another process that is executed by the information processing device 30 in the first embodiment;

FIG. 7 is a diagram conceptually showing the construction of an abnormality cause information management system 2 in accordance with a second embodiment of the invention;

FIG. 8 shows an example of a set of supervised training data in which the cause of an abnormality and the feature quantities of FFD are associated in correspondence in the second embodiment; and

FIG. 9 is a diagram showing how the cause of an abnormality is estimated from the present FFD in the second embodiment.

### DETAILED DESCRIPTION OF EMBODIMENTS

Best modes for carrying out the invention will be described with reference to the accompanying drawings, using embodiments as examples.

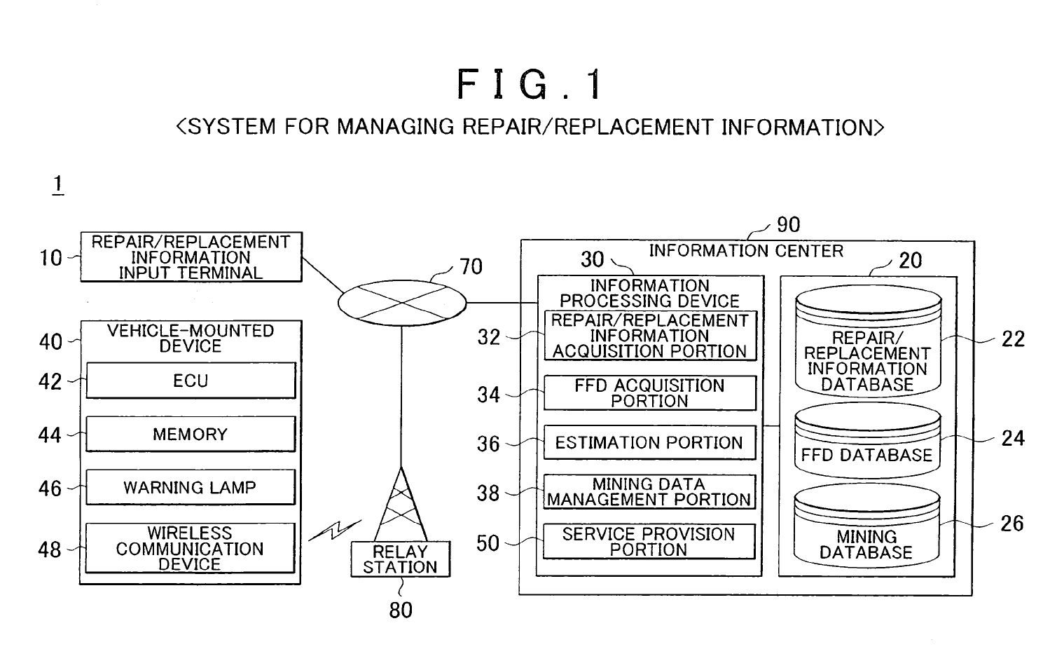

Firstly, an overall construction of a repair/replacement information management system 1 in accordance with a first embodiment of the invention will be described. FIG. 1 is a diagram conceptually showing the construction of the repair/replacement information management system 1 in accordance with the first embodiment of the invention. The repair/replacement information management system 1 includes a repair/replacement information input terminal 10, a storage device 20, and an information processing device 30, as main components.

The repair/replacement information input terminal 10 is installed, for example, in each of a plurality of repair shops (or dealer's shops, which statement will be omitted below). Into the input terminal 10, the type of repair or parts replacement performed at the repair shop is input together with the vehicle ID, the date, etc. (hereinafter, termed the repair/replacement information). The repair/replacement information is sent to the information processing device 30 via a network 70, for example, the Internet, or the like.

The storage device 20 and the information processing device 30 are installed in an information center 90 that is a service facility that is run by, for example, a car maker or the like. The storage device 20 is a storage device which uses, for example, a hard disk drive (HDD), a digital versatile disk (DVD), a magnetic tape, etc., and in which a repair/replacement information database 22, a freeze-frame-data (FFD) database 24, and a mining database 26 are built.

The repair/replacement information database 22 stores the contents of repair or replacement that are input to the repair/replacement information input terminal 10.

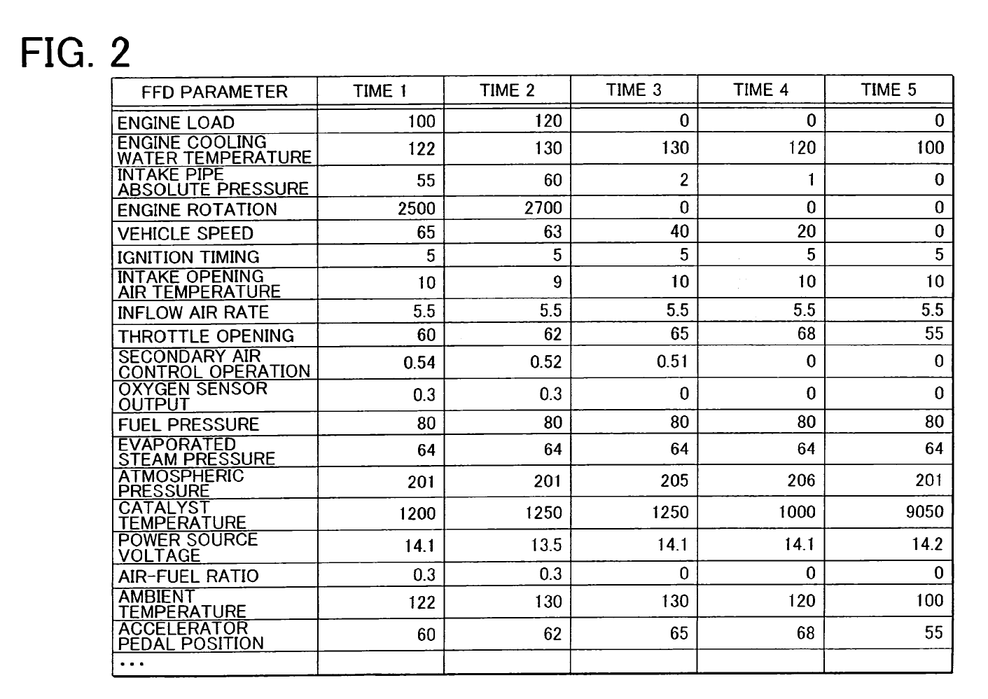

The FFD database 24 stores FFD that is collected by the vehicle when an abnormality occurs in the vehicle. The pieces of FFD correspond one-to-one to the pieces of the repair/replacement information stored in the repair/replacement information database 22. The FFD is data in which the output values of the vehicle-mounted sensors, state signals, control signals, etc., produced when an abnormality occurs are stored in a time series, as shown in FIG. 2. Due to this, the FFD collected at the vehicle with regard to an abnormality of the vehicle, and the type of repair or parts replacement carried out to remove the abnormality of the vehicle can be referred to in a combined unit. More concretely, for example, an abnormality identification code that shows what abnormality is concerned may be assigned to each piece of FFD or repair/replacement information, or FFD identification numbers may be assigned to pieces of repair/replacement information.

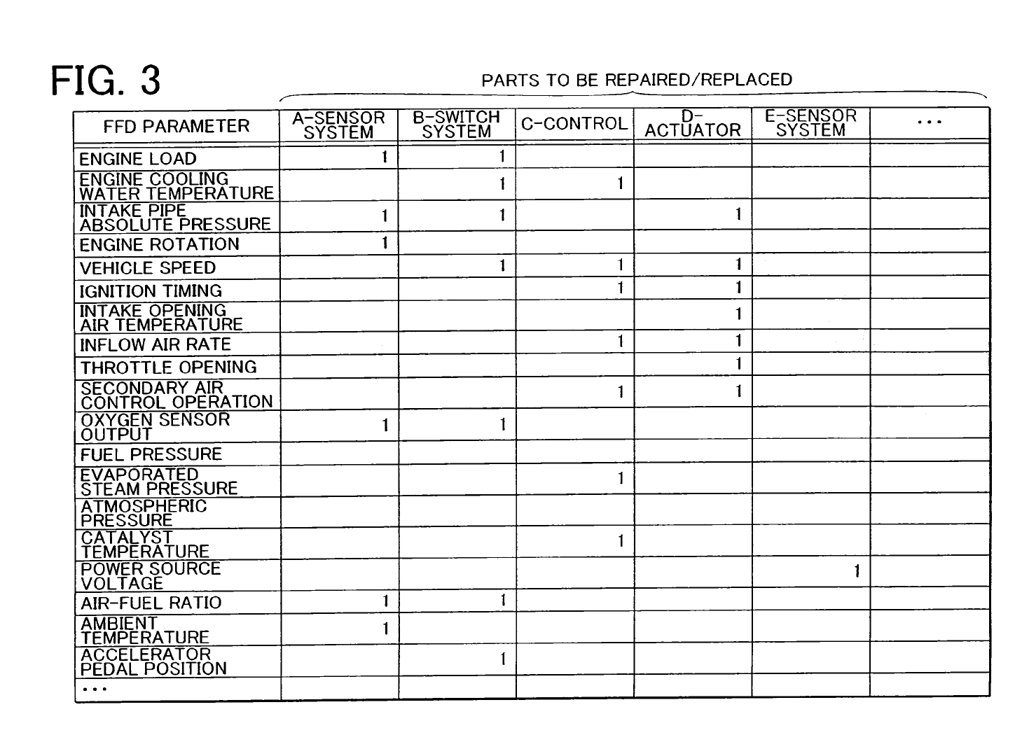

The mining database 26 stores a plurality of sets of supervised training data (mining data) in which the feature quantities of FFD and pieces of repair/replacement information are associated with each other in correspondence. It is to be noted herein that the feature quantities of FFD are quantities converted as parameters from the items that exhibit changes greater than or equal to a predetermined degree at the time point of change of FFD. In the case of the FFD shown in FIG. 2, it can be seen that the engine load, the intake pipe absolute pressure, the engine rotation speed, the oxygen sensor output and the air-fuel ratio changed during the period of time 2 to time 3. Therefore, the feature quantities of FFD are obtained, for example, by representing the engine load, the intake pipe absolute pressure, the engine rotation speed, the oxygen sensor output and the air-fuel ratio by value 1, and representing the other items by value 0. FIG. 3 shows an example of the supervised training data in which the component parts to be repaired or replaced and the feature quantities of FFD are associated in correspondence. In addition, each piece of the supervised training data stored in the mining database 26 may also be assigned with an attribute for distinguishing whether the piece of data is in the provisionally registered state or the definitively registered state.

The information processing device 30 is, for example, a microcomputer that has a central processing unit (CPU) as a center component to which a read-only memory (ROM), a random access memory (RAM), etc. are interconnected via a bus, and further includes a storage device, such as a flash memory or the like, as well as I/O ports, a timer, a counter, etc. The ROM stores programs that the CPU executes, and also data. The information process device 30 has a repair/replacement information acquisition portion 32, an FFD acquisition portion 34, an estimation portion 36, a mining data management portion 38, and a service provision portion 50 as main functional blocks that function when the CPU executes a program stored in the ROM.

The repair/replacement information acquisition portion 32 acquires repair/replacement information from the repair/replacement information input terminal 10 via the network 70 as described above, and controls the storage device 20 so that the acquired repair/replacement information is added to the repair/replacement information database 22.

The FFD acquisition portion 34 controls the storage device 20 so that the FFD acquired from vehicle-mounted devices 40 (only one reference number is mentioned for simplification) mounted in a plurality of vehicles are added to the FFD database 24.

[EXAMPLE OF CONSTRUCTION OF VEHICLE-MOUNTED DEVICE] Herein, the construction of a vehicle-mounted device 40, and the content of the FFD will be described. The vehicle-mounted device 40 has an electronic control unit (ECU) 42, a memory 44, a warning lamp 46, a wireless communication device 48, etc. The ECU 42 is, for example, a microcomputer, into which the engine load, the engine cooling water temperature, the intake pipe absolute pressure, the engine rotation speed, and the vehicle speed as well as other sensor output values, state signals, control signals, etc.

The ECU 42 constantly monitors these values, and periodically determines (e.g., every several tenths second) whether or not any abnormality has occurred in the vehicle. If the ECU 42 determines that an abnormality has occurred in the vehicle, the ECU 42 turns on or blinks the warning lamp 46, and stores the input values before and after the determination into the memory 44 as time-series data, that is, as FFD. The FFD is, for example, data input during a period from a first predetermined time prior to the time point at which it is determined that the abnormality has occurred till a second predetermined time (normally, the first predetermined time>the second predetermined time) following that time point. In addition, the ECU 42 may also perform these processes concurrently with other roles (including the engine control, the brake control, the steering control, etc.).

The memory 44 is, for example, an electronically erasable and programmable read-only memory (EEPROM), or a non-volatile RAM (NVRAM) formed of a static random access memory (SRAM) with a small electric cell provided within or disposed outside the memory. Besides, the memory 44 may also be a storage medium such as a flash memory, a magnetic tape, paper (print paper), etc.

A user, seeing the warning lamp 46 turned on or blinking, takes the vehicle to a repair shop, and asks for repair or the like. Then, at the repair shop, the FFD is displayed on a monitor or the like, and repair or parts replacement corresponding to the FFD is performed. Besides, the content of the repair or parts replacement is input as repair/replacement information as described above, and is sent to the information processing device 30.

At a predetermined timing after it is determined that an abnormality has occurred, the ECU 42 commands the wireless communication device 48 to send the information stored as FFD in the memory 44 to the information processing device 30. This predetermined timing may be immediately subsequent to the determination of occurrence of the abnormality, or may also be a predetermined time following the determination, or may also be the time when repair is performed at the repair shop. In the last case, it is not altogether necessary to use wireless communication, but it is also permissible to connect the vehicle to a network terminal of the repair shop in order to send information.

The sending of information from the wireless communication device 48 to the information processing device 30 is performed, for example, via a relay station 80 and the foregoing network 70. The ending of information from the wireless communication device 48 to the relay station 80 is performed by using an electromagnetic wave network of cellular phones, a personal handy-phone system (PHS) network, a wireless LAN, a worldwide interoperability for microwave access (WiMAX), a satellite telephone network, the BEACON, etc.

Next, process during early period of system operation is explained. Due to the foregoing construction, the information processing device 30 is able to acquire the repair/replacement information and the FFD in a combined set. Hereinafter, the processing of the information acquired will be described.

Firstly, a process performed during an early period of operation of the repair/replacement information management system 1 will be described. Until a certain number of units (e.g., about 100 units) of supervised training data are stored, the feature quantities of FFD and the repair/replacement information are associated with each other in correspondence without condition, and are stored as pieces of supervised training data in the mining database 26 (a provisionally registered state). Then, the estimation portion 36 and the mining data management portion 38 perform an estimation process and an accordance determination between each piece of supervised training data stored and other stored pieces of supervised training data.

The estimation portion 36 extracts a unit of supervised training data (termed D1 herein), and detects feature quantities thereof. The estimation portion 36 detects a time point of change of FFD, and therefore detects feature quantities thereof. In the case of the set of FFD shown in FIG. 2, the engine load, the intake pipe absolute pressure, the engine rotation speed, the oxygen sensor output, and the air-fuel ratio changed from time 2 to time 3. The estimation portion 36 represents these items as value 1, and represents the other items as blank, and thus detects this representation as feature quantities of the FFD. In addition, the time point of change can be defined as a time point at which the greatest number of items exhibited a change to at least a predetermined degree.

Then, the estimation portion 36 extracts another set of supervised training data (termed D2 herein) that has high correlation with the detected feature quantities of the FFD, and estimates that the content of the repair or replacement described by the repair/replacement information contained in the supervised training data D2 is the repair or replacement that needs to be carried out to remove the abnormality indicated by the supervised training data D1.

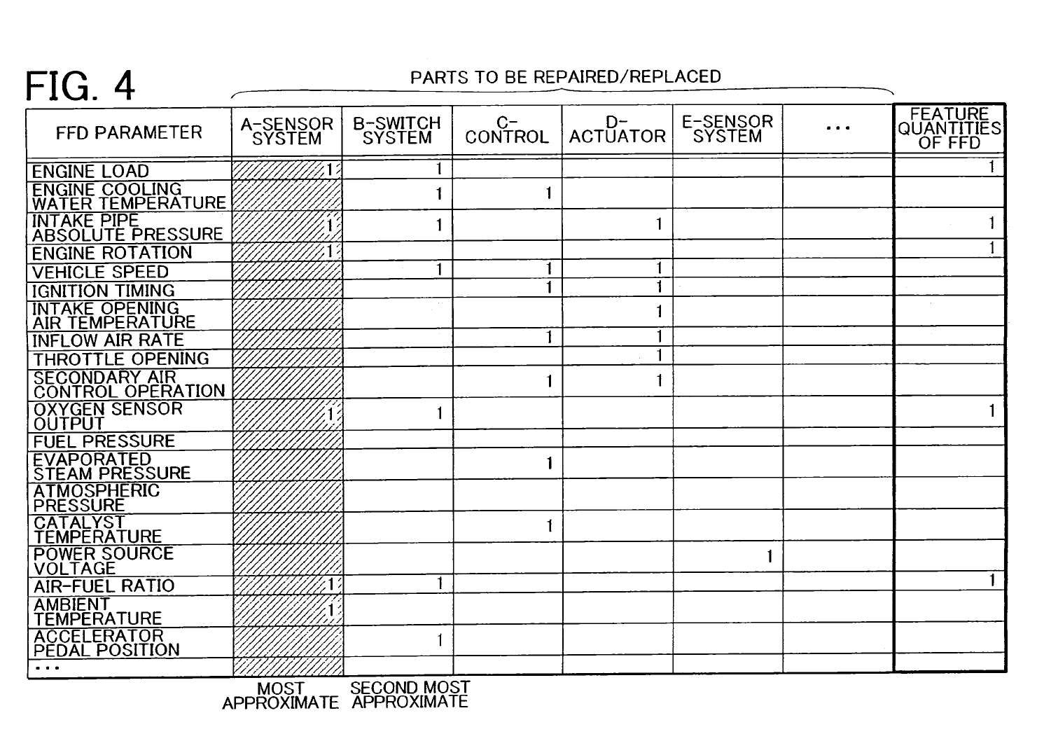

If as shown in FIG. 4, the FFD shown in FIG. 2 is of the supervised training data D1, the feature quantities thereof are the most approximate to the feature quantities of FFD given for the case where the A sensor system is to be repaired or replaced, and are the second most approximate to the feature quantities of FFD given for the case where the B switch system is repaired or replaced. Therefore, from the FFD of the supervised training data D1, it is estimated that the A sensor system needs to be repaired or replaced.

Then, if the estimated content of repair or replacement accords with the content of repair or replacement that is described by the repair/replacement information contained in the supervised training data, the mining data management portion 38 causes the supervised training data to remain in the mining database 26 (state of definitive registration). If accordance therebetween is not recognized, the mining data management portion 38 deletes the supervised training data from the mining database 26. This process will be referred to as “the self-inspection” below. In addition, in the case where accordance therebetween is not recognized, the supervised training data may be given an attribute or the like that indicates that the supervised training data will not be used as supervised training data, instead of being deleted from the mining database 26.

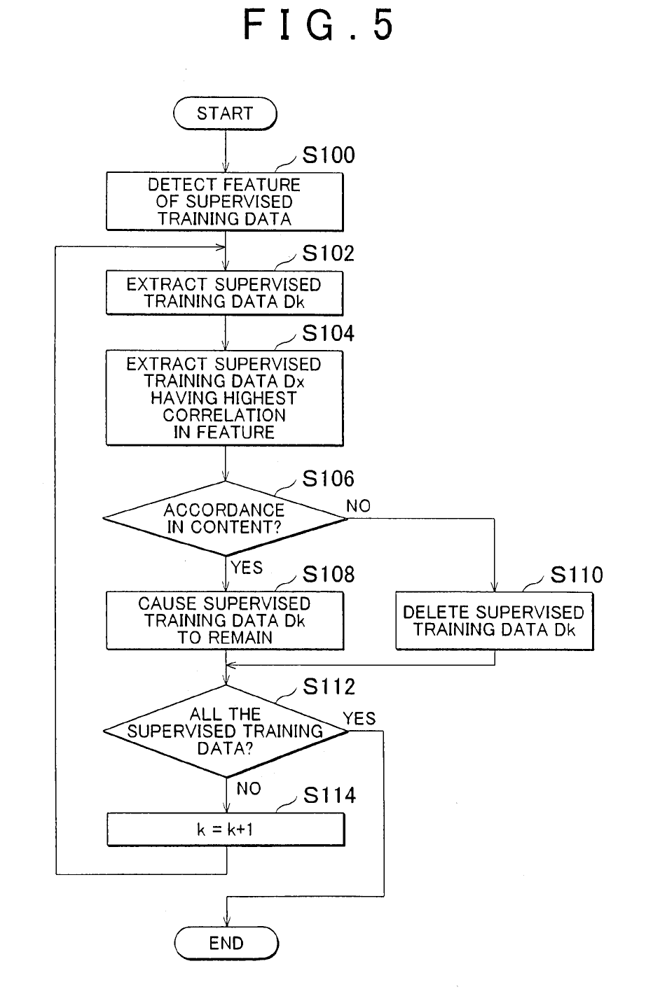

This process is performed on each set of supervised training data. FIG. 5 is a flowchart showing a flow of the process concerned with the self-inspection.

Firstly, feature quantities of each unit of supervised training data D1 to Dn is detected (S100).

Then, the supervised training data Dk is extracted (S102). Incidentally, the argument k shows the number of the supervised training data, and is set at 1 when this flow of process has just begun. Then, the feature quantities of the supervised training data Dk are compared with the feature quantities of each of the other units of supervised training data (D1 to Dk−1, and Dk+1 to Dn), and the unit of supervised training data Dx with the highest correlation in the feature quantities is extracted (S104).

Subsequently, it is determined whether or not the content of repair or replacement contained in the supervised training data Dk accords with the content of repair or replacement contained in the supervised training data Dx (S106).

If the content of repair or replacement contained in the supervised training data Dk accords with the content of repair or replacement contained in the supervised training data Dx, the supervised training data Dk is retained in the mining database 26 (the definitively registered state is brought about) (S108).

On the other hand, if the content of repair or replacement contained in the supervised training data Dk does not accord with the content of repair or replacement contained in the supervised training data Dx, the supervised training data Dk is deleted from the mining database 26 (S110).

Then, it is determined whether or not the process of S102 to S110 has ended with regard to all the sets of supervised training data (S112). For example, if the argument k is equal to n, it is determined that the process has ended with regard to all the sets of supervised training data.

When it is determined that the process has ended with regard to all the sets of supervised training data, this flow ends. On the other hand, when it is determined that the process has not ended with regard to all the sets of supervised training data, the argument k is increased by 1 (S114), and then the process returns to S102.

Due to this process, the supervised training data whose correlation with the other supervised training data is low is excluded. Therefore, a group of supervised training data that can serve as a reference can be appropriately extracted.

The repair/replacement information and the acquired FFD are stored firstly in the repair/replacement information database 22 and the FFD database 24 as described above. Then, after being subjected to an estimation process performed by the estimation portion 36, the repair/replacement information and the FFD are added to the mining database 26 by the mining data management portion 38 under a predetermined condition.

When a new piece of repair/replacement information is added to the repair/replacement information database 22 (a certain number of pieces of repair/replacement information may be accumulate, and may be collectively processed), the estimation portion 36 reads from the FFD database 24 FFD that corresponds to the new piece of repair/replacement information, and estimates the content of repair or parts replacement by using the read FFD, and the supervised training data stored in the mining database 26.

Then, the estimation portion 36, as in the process of self-inspection, extracts supervised training data whose correlation with the feature quantities of the presently detected FFD is high, and estimates the content of repair or replacement described by the repair/replacement information contained in the supervised training data that has the highest correlation, as the content of repair or replacement that needs to be carried out to remove the present abnormality.

If the content of repair or replacement estimated by the estimation portion 36 accords with the repair/replacement information stored in the repair/replacement information database 22, the mining data management portion 38 adds to the mining database 26 a combination of the feature quantities of the FFD detected by the estimation portion 36 and the repair/replacement information stored in the repair/replacement information database 22, and deletes the combination of the FFD and the repair/replacement information from the repair/replacement information database 22 and the FFD database 24. On the other hand, if the content of repair or replacement estimated by the estimation portion 36 does not accord with the repair/replacement information stored in the repair/replacement information database 22, the mining data management portion 38 simply deletes the combination of the FFD and the repair/replacement information from the repair/replacement information database 22 and the FFD database 24.

Due to the foregoing process, in the case where the content of repair or parts replacement carried out at a repair shop corresponding to the FFD accords with supervised training data stored in the past, the feature quantities of the FFD and the repair/replacement information are associated with each other in correspondence, and are added to the supervised training data. Therefore, the state of the vehicle detected at the time of occurrence of an abnormality of the vehicle, and the repair or parts replacement that needs to be carried out can be associated in correspondence with each other at high accuracy.

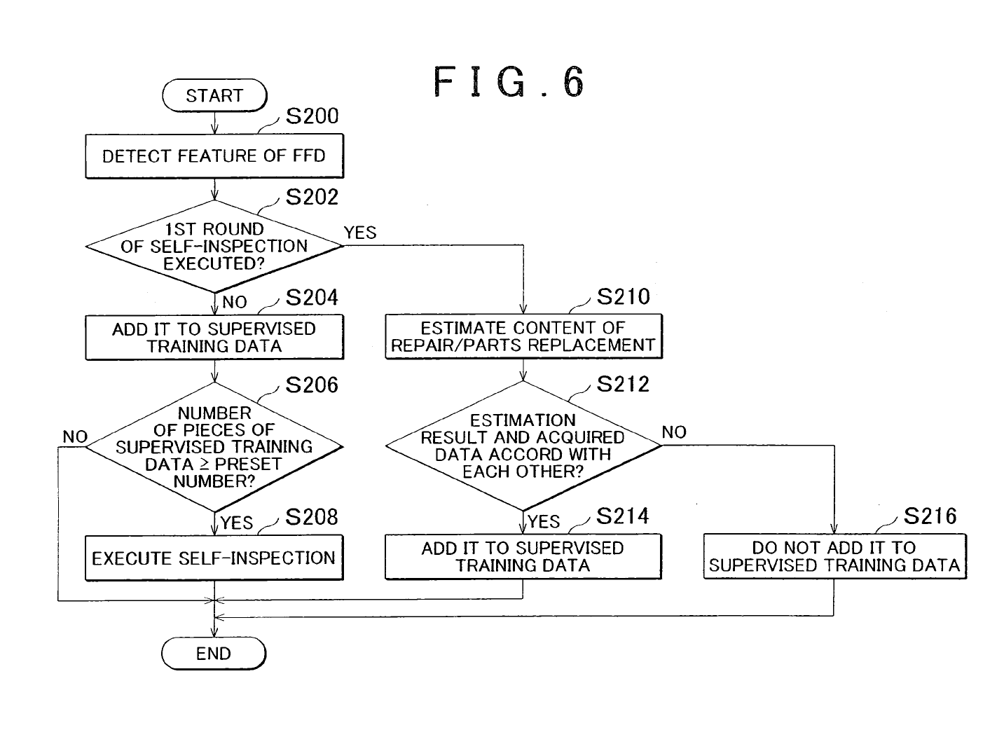

FIG. 6 is an example of a flowchart showing the flow of the foregoing process that is executed by the information processing device 30. This flow of the process is executed at a timing at which repair/replacement information and FED are acquired by the repair/replacement information acquisition portion 32 and the FFD acquisition portion 34, and are stored into the storage device 20.

Firstly, the feature quantities of the acquired FFD are detected (S200).

Then, it is determined whether or not the first round of the self-inspection has already been performed (S202).

In the case where the first round of the self-inspection has not been performed, the combination of the feature quantities of the FFD detected in S100 and the repair/replacement information stored in the repair/replacement information database 22 is added to the supervised training data (S204), and it is determined whether or not the number of pieces of the supervised training data is greater than or equal to a predetermined number (S206). In the case where the number of pieces of the supervised training data is less than the predetermined number, the present cycle of this flow is ended without performing any further processing. In the case where the number of pieces of the supervised training data is greater than or equal to the predetermined number, the self-inspection is executed (S208). At this time, if a self-inspection execution-completed flag is set in an internal memory or the like of the information processing device 30, it will be useful for the determination in S102.

On the other hand, in the case where the first round of the self-inspection has already been performed, the content of repair or replacement is estimated (S210) on the basis of the feature quantities of the FED and the supervised training data detected in S100. Then, it is determined whether or not the result of the estimation (i.e., the estimated content) accords with the content of repair or replacement contained in the repair/replacement information (S212). In the case where there is accordance therebetween, the combination of the feature quantities of the FFD detected in S100 and the repair/replacement information stored in the repair/replacement information database 22 is added to the mining database 26 (S214). In the case where there is not accordance therebetween, the combination not is added to the mining database 26 (S216).

Incidentally, it is also preferable to periodically perform the self-inspection after the first round of the self-inspection is performed. Therefore, the state of the vehicle detected at the time of occurrence of an abnormality of the vehicle, and the content of repair or parts replacement to be carried out can be more accurately associated in correspondence.

Hereinafter, the provision of information services based on the supervised training data accumulated as described above will be described below. The service provision portion 50 manages a service-providing web site, and allows the service-providing web site to be read at a repair shop (that may be the same repair shop as the foregoing repair shop as the information source, or may also be different therefrom). At the repair shop, by accessing the service-providing web site and then inputting the FED, the information processing device 30 can be caused to estimate the content of repair or replacement, and the result of the estimation can be received and read as reference for the repair or parts replacement.

Such services can be provided concurrently with the foregoing addition/deletion of supervised training data. Specifically, when a vehicle is brought into a repair shop by a user, FFD is sent from the vehicle to the information processing device 30 according to a predetermined operation or the like, and the information processing device 30 displays the result of the estimation on the service-providing web site. At the repair shop, the repair or parts replacement is performed with reference to the result of measurement shown in the service-providing web site, and repair/replacement information is input to the repair/replacement information input terminal 10. Then, the information processing device 30 determines whether or not the estimation result and the content of repair or replacement that is actually performed accord with each other. In the case where they accord with each other, the combination of the feature quantities of FFD and the repair/replacement information are associated in correspondence, and are added to the mining database 26. In this manner, the repair shop can be an information source for this system, and can also receive services from the system.

According to the foregoing repair/replacement information management system 1 of this embodiment, the state of the vehicle detected when an abnormality of the vehicle occurs, and the content of repair or parts replacement that needs to be carried out can be highly accurately associated in correspondence.

Incidentally, if this system is tempered with a process of follow-up survey in the market (surveying, for example, whether or not a performance of repair or parts replacement is followed by another performance of the same repair or parts replacement), it becomes possible to heighten the accuracy in the foregoing association in correspondence.

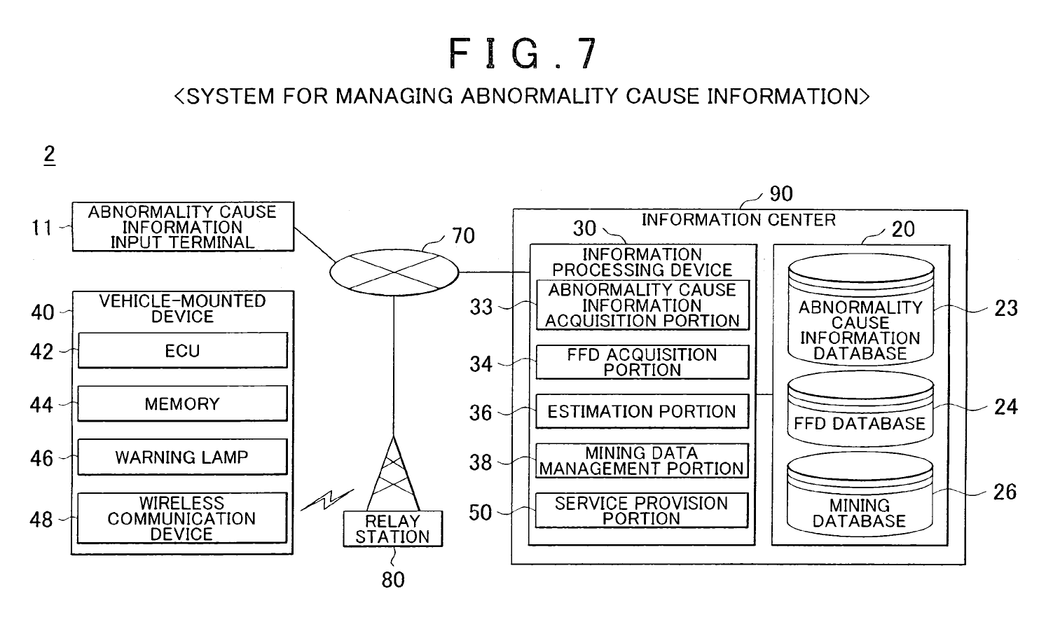

An abnormality cause information management system 2 in accordance with a second embodiment of the invention will be described below, firstly with regard to an overall construction thereof. FIG. 7 is a diagram conceptually showing a construction of the repair/replacement information management system 2 of the second embodiment of the invention. The repair/replacement information management system 2 includes an abnormality cause information input terminal 11, a storage device 20, and an information processing device 30 as main components. Hereinafter, component elements of the second embodiment having substantially the same functions as those of the first embodiment are represented by the same reference characters as in the first embodiment, and detailed descriptions thereof are omitted below.

The abnormality cause information input terminal 11 is installed, for example, in each of a plurality of repair shops (or dealer's shops, which statement will be omitted below). Into the input terminal 11, the cause of the abnormality determined at a repair shop is input together with the vehicle ID, the date, etc. (hereinafter, termed the abnormality cause information). The abnormality cause information is sent to an information processing device 30 via a network 70, for example, the Internet, or the like.

In the storage device 20, an abnormality cause information database 23, an FFD (freeze flame data) database 24, and a mining database 26.

The abnormality cause information database 23 stores the contents of repair or replacement that are input to the abnormality cause information input terminal 11.

The FFD database 24 is substantially the same as that in the first embodiment, and description thereof will be omitted.

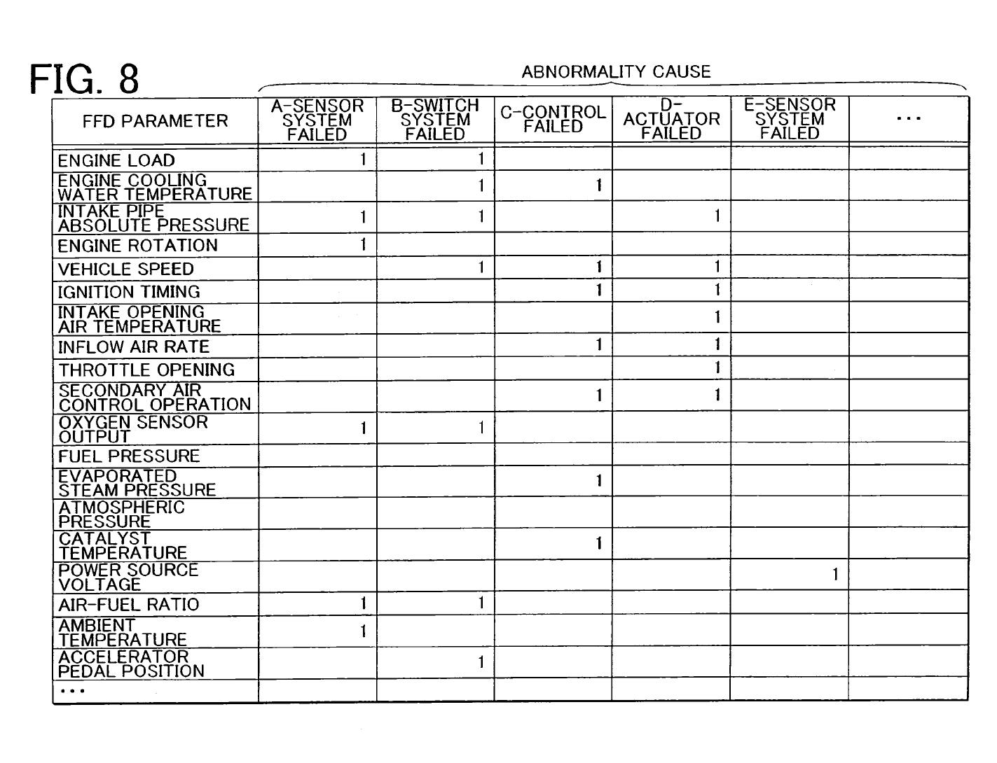

The mining database 26 stores a plurality of sets of supervised training data (mining data) in which the feature quantities of FFD and pieces of abnormality cause information are associated with each other in correspondence. FIG. 8 shows an example of the supervised training data in which abnormality causes and the feature quantities of FFD are associated in correspondence.

The information processing device 30 in this embodiment has an abnormality cause information acquisition portion 33, an FED acquisition portion 34, an estimation portion 36, a mining data management portion 38, and a service provision portion 50, as main functional blocks that are caused to function by the CPU executing programs stored in the ROM.

The abnormality cause information acquisition portion 33 acquires abnormality cause information from the abnormality cause information input terminal 11 via the network 70 as described above, and controls the storage device 20 so that the information is added to the abnormality cause information database 23.

The FFD acquisition portion 34, and the example of construction of vehicle-mounted device in this embodiment are substantially the same as in the first embodiment, and description thereof are omitted below.

Due to the foregoing construction, the information processing device 30 is able to acquire abnormality cause information and FFD in a combined set. Hereinafter, processes characteristic of the invention with regard to the acquired information will be described.

The acquired abnormality cause information and the acquired FFD are firstly stored in the abnormality cause information database 23 and the FFD database 24 as described above. Then, after being processed through the estimation process performed by the estimation portion 36, the combined set of abnormality cause information and FFD is added to the mining database 26 by the mining data management portion 38 under a predetermined condition.

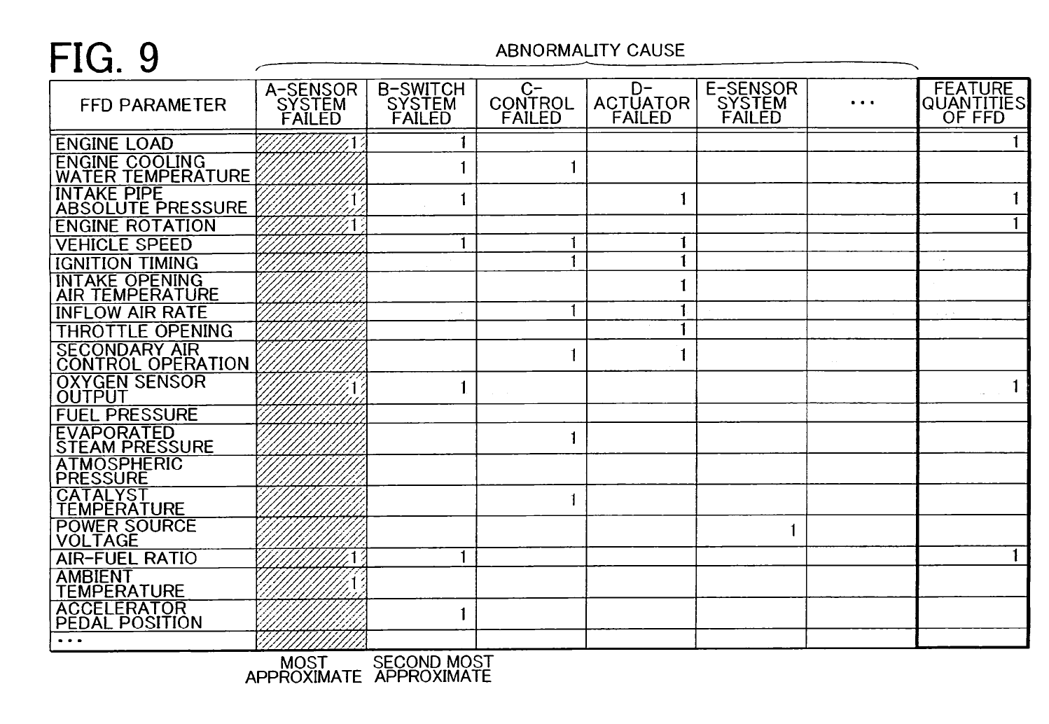

When a new piece of repair/replacement information is added to the repair/replacement information database 22, the estimation portion 36 reads from the FFD database 24 FFD that corresponds to the new piece of repair/replacement information, and estimates the content of repair or parts replacement by using the read FFD, and the supervised training data stored in the mining database 26. The estimation of abnormality cause is performed on the basis of a principle that is substantially the same as in the estimation of repair and parts-replacement described above in conjunction with the first embodiment. As shown in FIG. 9, if estimation is performed using the FFD shown as an example in FIG. 2 and the supervised training data also shown as an example in FIG. 8, it is estimated that the cause of the abnormality is a failure of the A sensor system.

If the abnormality cause estimated by the estimation portion 36 accords with the abnormality cause information stored in the abnormality cause information database 23, the mining data management portion 38 adds to the mining database 26 a combination of the feature quantities of the FFD detected by the estimation portion 36 and the abnormality cause information stored in the abnormality cause information database 23, and deletes that combination of the FFD and the abnormality cause information from the abnormality cause information database 23 and the FFD database 24. On the other hand, if they do not accord with each other, the mining data management portion 38 simply deletes the combination of the FFD and the abnormality cause information from the abnormality cause information database 23 and the FFD database 24.

Due to the foregoing process, in the case where the abnormality cause determined at a repair shop corresponding to the FFD accords with the supervised training data accumulated in the past, the feature quantities of the FFD and the abnormality cause are associated in correspondence, and are added to the supervised training data. Therefore, the state of the vehicle detected at the time of occurrence of an abnormality of the vehicle, and the abnormality cause can be associated with each other in correspondence at high accuracy.

The processes during an early period of operation of the system, the flows of the processes, the provision of services are similar to those in the first embodiment, and descriptions thereof are omitted below.

According to the repair/replacement information management system 2 of the foregoing embodiment, the state of the vehicle detected at the time of occurrence of an abnormality of the vehicle, and cause of the abnormality can be highly accurately associated with each other in correspondence.

In this system, too, if this system is tempered with a process of follow-up survey in the market (surveying, for example, whether or not an operation of repair or parts replacement is followed by another operation of the same repair or parts replacement), it becomes possible to heighten the accuracy in the foregoing association in correspondence.

While best modes, for carrying out the invention have been described above through the use of the embodiments, the invention is not limited to these embodiments at all, but various modifications and replacement can be made without departing from the spirit of the invention.

For example, although the FFD, that is time-series data including a plurality of items, is shown as an example of the information that represents the state of the vehicle detected at the vehicle when an abnormality of the vehicle occurs, the information that represents the state of the vehicle may also be information in other forms.

The invention is applicable to the Motor vehicle manufacturing industry, the motor vehicle Parts manufacturing industry, etc.

1. A system for managing vehicle repair/replacement information comprising:
a repair/replacement information acquisition device that acquires repair/replacement information that represents a content of repair or parts replacement that has been actually performed to remove an abnormality of a vehicle;
a vehicle state information acquisition device that acquires vehicle state information at an occurrence of abnormality of the vehicle, said vehicle state information representing a state of the vehicle;
a storage device that stores the acquired vehicle state information and the acquired repair/replacement information as a plurality of units of supervised training data in each of which the vehicle state information and the repair/replacement information are associated; and
an information processing device that detects a feature of the vehicle state information of each unit of supervised training data stored in the storage device, and that retains a unit of supervised training data if the content of repair or parts replacement described by the repair/replacement information contained in the unit of supervised training data accords with the content of repair or replacement described by the repair/replacement information contained in another unit of supervised training data stored whose detected feature is most closely correlated to the detected feature of the unit, and does not use a unit of supervised training data if the content of repair or parts replacement described by the repair/replacement information contained in the unit of supervised training data does not accord with the content of repair or replacement described by the repair/replacement information contained in another unit of supervised training data stored whose detected feature is most closely correlated to the detected feature of the unit.

2. The system for managing repair/replacement information according to claim 1, wherein
the vehicle state information is time-series data that has a plurality of items, and the information processing device detects, as the feature of the vehicle state information, a changed-item pattern occurring at a time point of change of the vehicle state information acquired by the vehicle state information acquisition device.

3. The system for managing repair/replacement information according to claim 1, wherein
the information processing device performs, at a predetermined timing, a process of deleting each piece of data which is contained in the supervised training data stored in the storage device, and whose correlation with other pieces of data is low.

4. The system for managing repair/replacement information according to claim 1, further comprising
an information providing device that provides information for a user, wherein when the vehicle state information acquisition device acquires the vehicle state information, the information processing device performs a function of detecting the feature of the vehicle state information acquired by the vehicle state information acquisition device, and estimating the content of repair or parts replacement by using the detected feature of the vehicle state information, and the supervised training data, and controlling the information providing device so as to provide the user with a result of estimation of the content of repair or parts replacement.

5. A device for managing vehicle repair/replacement information, comprising:
a storage device that stores vehicle state information and repair/replacement information as a plurality of units of supervised training data in each of which the vehicle state information and the repair/replacement information are associated; and
an information processing device that detects a feature of the vehicle state information of each unit of supervised training data stored in the storage device, and that retains a unit of supervised training data if a content of repair or parts replacement described by the repair/replacement information contained in the unit of supervised training data accords with the content of repair or replacement described by the repair/replacement information contained in another unit of supervised training data stored whose detected feature is most closely correlated to the detected feature of the unit, and does not use a unit of supervised training data if the content of repair or parts replacement described by the repair/replacement information contained in the unit of supervised training data does not accord with the content of repair or replacement described by the repair/replacement information contained in another unit of supervised training data stored whose detected feature is most closely correlated to the detected feature of the unit.

6. A method of processing a plurality of units of supervised training data which are stored in a storage device and in each of which vehicle state information and repair/replacement information are associated, comprising:
detecting a feature of the vehicle state information of each unit of supervised training data;
determining, with regard to each unit of supervised training data, whether or not a content of repair or parts replacement described by the repair/replacement information contained in the unit of supervised training data accords with the content of repair or replacement described by the repair/replacement information contained in another one of the units stored whose detected feature is most closely correlated to the detected feature of the unit; and
retaining the unit of supervised training data if the content of repair or replacement described in the unit accords with the content of repair or replacement described in the another one of the units, and not using the unit of supervised training data if the content of repair or replacement described in the unit does not accord with the content of repair or replacement described in the another one of the stored units.

7. A system for managing vehicle abnormality cause information comprising:
an abnormality cause information acquisition device that acquires abnormality cause information, said abnormality cause information showing a cause of an abnormality of a vehicle;
a vehicle state information acquisition device that acquires vehicle state information at an occurrence of abnormality of the vehicle, said vehicle state information representing a state of the vehicle;
a storage device that stores the acquired vehicle state information and the acquired abnormality cause information as a plurality of units of supervised training data in each of which the abnormality cause information and a feature of the vehicle state information are associated; and
an information processing device that detects the feature of the vehicle state information of each unit of supervised training data stored in the storage device, and that retains a unit of supervised training data if a content of the abnormality cause information described by the abnormality cause information contained in the unit of supervised training data accords with the content of the abnormality cause information described by the abnormality cause information contained in another unit of supervised training data stored whose detected feature is most closely correlated to the detected feature of the unit, and does not use a unit of supervised training data if the content of the abnormality cause information described by the abnormality cause information contained in the unit of supervised training data does not accord with the content of the abnormality cause information described by the abnormality cause information contained in another unit of supervised training data stored whose detected feature is most closely correlated to the detected feature of the unit.

8. The system for managing abnormality cause information according to claim 7, wherein
the vehicle state information is time-series data that has a plurality of items, and the information processing device detects, as the feature of the vehicle state information, a changed-item pattern occurring at a time point of change of the vehicle state information acquired by the vehicle state information acquisition device.

9. The system for managing abnormality cause information according to claim 7, wherein
the information processing device performs, at a predetermined timing, a process of deleting each piece of data which is contained in the supervised training data stored in the storage device, and whose correlation with other pieces of data is low.

10. The system for managing abnormality cause information according to claim 7, further comprising:
an information providing device that provides information for a user, wherein when the vehicle state information acquisition device acquires the vehicle state information, the information processing device performs a function of detecting the feature of the vehicle state information acquired by the vehicle state information acquisition device, and estimating the cause of the abnormality by using the supervised training data and the detected feature of the vehicle state information, and controlling the information providing device so as to provide the user with a result of estimation of the cause of the abnormality.

11. A device for managing vehicle abnormality cause information, comprising:
a storage device that stores vehicle state information and repair-replacement information as a plurality of units of supervised training data in each of which vehicle state information and repair-replacement information are associated; and
an information processing device that detects a feature of the vehicle state information of each unit of supervised training data stored in the storage device, and that retains a unit of supervised training data if a content of the abnormality cause information described by the repair/replacement information contained in the unit of supervised training data accords with the content of the abnormality cause information described by the repair/replacement information contained in another unit of supervised training data stored whose detected feature is most closely correlated to the detected feature of the unit, and does not use a unit of supervised training data if the content of the abnormality cause information described by the abnormality cause information contained in the unit of supervised training data does not accord with the content of the abnormality cause information described by the repair/replacement information contained in another unit of supervised training data stored whose detected feature is most closely correlated to the detected feature of the unit.

12. A method of processing a plurality of units of supervised training data which are stored in a storage device and in each of which vehicle state information and repair/replacement information are associated, comprising:
detecting a feature of the vehicle state information of each unit of supervised training data;
determining, with regard to each unit of supervised training data, whether or not a content of abnormality cause information described by the repair/replacement information contained in the unit of supervised training data accords with the content of abnormality cause information described by the repair/replacement information contained in another one of the units stored whose detected feature is most closely correlated to the detected feature of the unit; and
retaining the unit of supervised training data if the content of the abnormality cause information described in the unit accords with the content of the abnormality cause information described in the another one of the units, and not using the unit of supervised training data if the content of the abnormality cause information described in the unit does not accord with the content of the abnormality cause information described in the another one of the units.
